(19) United States
(12) Patent Application Publication
(10) Pub. No.: US 2017/0359525 A1
(43) Pub. Date: Dec. 14, 2017

(54) COMPLETE REMOTE SENSING BRIDGE INVESTIGATION SYSTEM

(71) Applicant: Gary J. Weil, St. Louis, MO (US)

(72) Inventor: Gary J. Weil, St. Louis, MO (US)

(73) Assignee: EnTech Engineering, Inc., Chesterfield, MO (US)

(21) Appl. No.: 15/638,144

(22) Filed: Jun. 29, 2017

Related U.S. Application Data
(63) Continuation-in-part of application No. 13/876,082, filed on Mar. 26, 2013, now abandoned.
(60) Provisional application No. 61/404,232, filed on Sep. 29, 2010.

(51) Int. Cl. H04N 5/33; G01S 13/88; G01S 19/14; G01S 17/02; G06K 9/00; G06T 7/00; G06F 17/30; G06Q 50/26

(52) U.S. Cl. CPC H04N 5/33; G06K 9/00637; G01S 13/885; G06T 7/0004; G01S 19/14; G01S 17/023; G06T 2207/30184; G06Q 50/26; G06F 17/30241

(57) ABSTRACT

Selectively mobile system and method detect and locate information to determine repair or replacement needs for bridge and roadway infrastructure by detection of subsurface defects. Multiple sensors collect data to be fused include 1) Visual capture device or devices [16] aboard a mobile carrier [10] capture visual spectrum in either HD or regular video and/or as still frame camera images; 2) Infrared spectrum sensors [18] aboard the mobile carrier capture video or still frame images; 3) Global positioning sensors (GPS) [12] aboard the mobile carrier determine position; 4) Light detection and ranging system (LIDAR) aboard the mobile carrier gives precise locations. Further, 5) ground penetrating microwave radar (GPR) sensors carried by a vehicle [22] and related electronics determine depth of subsurface defects. The sensor systems supply data to a digital processor [40] having analysis and graphical information system (GIS) software [44] that fuses the data and presents it for delivery and use.

### CROSS-REFERENCE TO RELATED APPLICATIONS

This application is based upon and claims the priority of U.S. Utility patent application Ser. No. 13/876,082 filed Mar. 26, 2013, which claims the priority of PCT application No. PCT/US2011/001658, filed Sep. 26, 2011, which claims the priority of Provisional Application U.S. Ser. No. 61/404,232, filed Sep. 29, 2010, in the United States of America.

### TECHNICAL FIELD

This invention relates to the field of civil engineering, and to the condition monitoring of basic roadway and bridge infrastructure of the U.S.A. and world that allows the movement of people and goods throughout the world, and more generally to a system for structural bridge, roadway and parking area defect detection, and specifically to a complete remote sensing bridge investigation system.

### BACKGROUND

The United States has approximately 600,000 bridges 20 ft. long or longer. Most of these are associated with our Interstate Highway System that was begun in 1956. This means that most of the bridges in our nation are approaching, or are over, 50 years of age; twice their typical design life. Total replacement of these structures would cost over a trillion dollars and the efforts of millions of personnel hours. The national resources to accomplish this monumental task do not exist. Therefore these structures must be evaluated and maintained where possible. Even this scaled down effort is beyond the traditional technology and resources presently available. Trained engineers, inspectors, and money does not exist that can develop and implement a bridge inspection and maintenance program before these aging structures are so far deteriorated that they cannot be economically saved. This is going to lead to more catastrophic bridge failures such as I-35W Mississippi River bridge that carried Interstate 35 across the Mississippi River in Minneapolis, Minn. This bridge was Minnesota's fifth busiest, carrying 140,000 vehicles daily. During the evening rush hour on Aug. 1, 2007, it suddenly collapsed, killing 13 people and injuring 145.

Today, no standard method exists for evaluating bridges. States and municipalities may use in-house personnel or contractors; Engineers or non-engineers. Most inspections are performed by simple visual inspection. This is very subjective and not repeatable. The most sophisticated equipment usually employed is a 50-pound drag chain, which can sometimes detect concrete voids, but is useless when asphalt overlays are present, or traffic noise is too distracting. Sometimes cores are drilled, salt readings are taken or falling weight deflectometer tests are performed in isolated locations, not necessarily indicative of the entire structure's pavement. Unfortunately, no repeatable method is available that can evaluate an entire structure or tell the difference between a “half” or “full” depth concrete corrosion-caused delamination, so repair budgets are impossible to accurately develop. To make matters worse, simple structures may take teams of inspectors days to collect field data and write reports, while larger bridges may take weeks or months to evaluate and report their observations and tests results. A typical Midwestern state, Missouri, with almost 24,000 bridges was only able to inspect 76 bridges with their in-house 30-man team in 2009.

In 1988 the inventor worked assisted ASTM in writing the first bridge Remote Sensing inspection procedure, D4788 based upon a single remote sensing technique, IR Thermography. Since then the inventor has performed over 600 bridge condition inspections throughout the world. Some of these bridges were as small as 20 ft. long, and others as long as 5,400 ft. During this period the inventor realized various short comings in this basic single sensor investigation technique: 1) Data collection was very labor intensive using either walking techniques or slow moving vans carrying the sensors; 2) Anomaly areas were typically not marked or marked with nonpermanent chalk; 3) Reference measurements to a standard locations were rarely performed; 4) Because it could take many hours to inspect a single bridge deck, ambient conditions such as temperatures, wind speeds, and relative humidity would change throughout the investigation making constant recalibrations necessary; 5) Costly traffic control was required for the many hours required for each investigation; 6) Solar loading of the concrete areas was continually changing during each investigation which caused shadow areas not able to be investigated due to the need for significant recalibrations; 7) No depth information was collected for any detected anomaly areas; 8) As a result of all of the above short comings, the data was not repeatable during repeat investigations which prevented the use of trending techniques which would allow the determination of the most economical future time to either repair or replace major concrete structural section of the bridges or roadways.

To solve some of the short comings of the basic IR based investigation technique, the inventor began to use Ground Penetrating Radar techniques in the late 1990's. This technique could solve one of the above problems; the ability to determine the depth of delaminations. With this information and basic unit costs per sq. ft. of half-depth and full-depth anomaly standard repair costs, algorithms could be developed to assist in determining repair budgets, including determining the cubic feet of concrete and/or asphalt needed for the repair. Unfortunately, most purveyors of this technology used it alone and it suffered shortcomings similar to those for IR based techniques, but worse because it proved to be very inefficient in both equipment and labor to collect and analyze its data.

In 2007, the inventor's company EnTech began development of its' newest investigation protocol iteration; designated EnTech's “EnSITE VII”™ DEVELOPMENT SYSTEM #8. This investigation system was specifically designed to address the enormous bridge inspection needs of the 21st century. This system, with multiple sensors mounted on synched helicopters and mobile ground based vans, was intended to use remote sensing exclusively to:

1. Perform a complete structural & associated access ramps 3D mapping survey investigation with accuracy of +/−2 cm in 3D space;

2. Detect and map all previous deck pavement repairs and existing surface spalling;

3. Detect asphalt overlay de-bonding;

4. Detect and map internal concrete and asphalt covered concrete deck pavement half-depth and full-depth delamination and internal corrosion areas;

5. Develop full defect statistics in both spreadsheet and image formats for easy interpretation and integration into client GIS systems;

6. All data collection must be totally repeatable, so when data collection is repeated every few years, trend analysis may be utilized to determine the most economical time to perform repairs, and/or to determine when replacement is to be performed;

7. Data collection on an average of 20 bridge structures should be able to be performed per 8 hr. day or night;

Because of this high throughput of data and large number of bridges that will be able to be tested each day, total bridge inspection costs can be substantially lower than traditional costs, while supplying more accurate and timely information than any other existing single techniques.

### SUMMARY OF THE DISCLOSURE

This new invention is a complete remote sensing bridge investigation system that provides a way to change the entire dynamics of bridge and/or roadway condition investigations. It replaces the past practices of taking days, weeks or months to collect limited amounts of qualitative and minimal sampling data with more comprehensive and more accurate quantitative data covering 100% of these structures. It also brings a new higher level of safety for both field inspectors and the travelling public by eliminating the need for bridge, roadway or lane closures. It will also dramatically lower the costs for performing bridge and roadway condition investigations by bringing the concept of volume pricing to a culture that in the past had used single structure pricing to gather information on which to make decisions on how where to spend tax payer money to maintain our country's basic bridge and roadway infrastructure. Lastly, the ability to use this invention to collect more types of information more accurately will allow better government estimates on repair costs to an industry that has experienced typical repair costs overruns of 800% to 1,600%. It can also be used to investigate areas other than bridges, such as roadway and parking areas as well as other paved surfaces.

The existing qualitative tools used individually and separately to perform limited sampling investigations include: visual inspections; pacing distance measurements; chain dragging; deflectometer; IR thermography; and ground penetrating radar. Each tool can be accurate, but their typical applications are based on their costs, which are typically extremely high on a per sq. ft. unit basis. Therefore, to meet typical cost and time requirements, each of these separate tools, if they are even considered, is used to sample typically less than 1% of a roadway or bridge structure.

The present invention includes assembling, utilizing and synchronizing (“synching”) six (6) technologies including: 1) Global Positioning System (GPS) to locate the general structure locations; 2) Light Detection and Ranging (LIDAR) used to replace general surveying services & to give precise locations to all of the other test results; 3) a Visual Imaging System (VIS) analysis using regular and high definition video & still photography to place on-deck observations; 4) Infrared Energy Pattern analysis (IR analysis) used to locate and discern half-depth and full-depth hidden corrosion caused void areas within concrete; and 5) Microwave Ground Penetrating Radar (GPR) system tools to calibrate the infrared energy pattern analysis data for determination of depth on 100% of the detected fault areas. Instead of using handheld tools, all of the field data collection components of the invention are mounted on helicopter or fixed wing aircraft and vehicles capable of collecting data while driving over the roadways and/or bridges at normal traffic speeds. Finally, the invention includes a Geographical Information System (GIS) feature and method of synchronizing (“synching”) all the various pieces of information into a single deliverable result or data collection that can integrate into the majority of standard information analysis systems used by transportation departments in U.S.A. and the world.

One of the most important attributes of the present invention is the way in which data from the infrared (IR) sensor and the ground penetrating radar (GPR) are fused together. In traditional practice as exemplified by ASTM Standard D4788, IR data is used to determine the existence of subsurface delaminations in concrete. By itself, it has no ability to establish the depth or severity of these artifacts. Its major attribute is that it is extremely efficient in evaluating large areas, such as concrete bridge decks. Conversely, microwave based ground penetrating radar systems excel at determining the depths of these types of artifacts, but these systems are extremely inefficient and labor intensive when evaluating bridge decks with their enormous quantities of concrete pavements for the locations of the artifacts. Instead of using these tools in their traditional manners, this new invention uses each of these sensors only in its most efficient manner: The IR sensor is used in the presently inventive system to detect the delaminations, while the microwave based sensor is used to establish the depth of each artifact. The presently disclosed GPS and LIDAR sensor systems are then used to establish the locations and scale of each of the artifacts. By being able to establish the depth and severity of each delamination along with an accurate location and size, a major problem experienced by all federal, state and local departments of transportation (DOTS) can be avoided.

The method of detecting, locating and evaluating bridge and roadway subsurface defects comprises flying an aircraft having an infrared camera and GPS device mounted on it over a selected surface of the bridge and roadway; operating the infrared camera and GPS device to scan the selected surface of the bridge and roadway and creating infrared data and GPS data; driving a vehicle having an odometer and a Ground Penetrating Radar device mounted on or under it over the selected surface of the bridge and roadway; operating the Ground Penetrating Radar device and scanning the selected surface of the bridge and roadway and create Ground Penetrating Radar data; wherein the Ground Penetrating Radar data and the odometer data are digitally stored in a data storage unit; wherein the infrared data and the GPS data are digitally stored in the data storage unit; wherein the Ground Penetrating Radar data, the odometer data, the infrared data and the GPS data are digitally transferred to a processor; wherein the GPS data is processed in a processor to determine each location (Lx, where x is an identifier, such as a number) for the Ground Penetrating Radar data and infrared data; wherein the Ground Penetrating radar data is processed by a processor to generate depth data for the determined location; wherein the infrared data is processed by the processor to generate energy level data for the determined location; wherein a calibration chart (see FIG. 14) for each location Lx is generated by plotting for each location on the Y-axis the infrared energy level and on the X-axis the Ground Penetrating Radar depth; and wherein the calibration chart is used to establish the depth and severity of the defects for each location. According to the calibration chart, the delamination locations can easily be divided into two groups. The smaller delaminations, with lower XY coordinates being labeled “half buckets”, shown in FIG. 10 as indicated in YELLOW (Y), and the larger, with higher XY coordinates being labeled “full buckets” and shown in FIG. 10 as RED (R).

Typical bridge repair costs overruns of 1,000% to 1,600% can be dramatically reduced or eliminated by use of the inventive new system. Highly accurate costs estimates can be determined by using empirical standards developed from past work; such as $10/ft.·2 for overlay debond repairs; $20/ft.·2 for half-depth delamination repairs and $80/ft·2 for full-depth delamination repairs. Not only will cost budgeting become more accurate because of the new system, but also contractor oversight will become the norm rather than the exception. The days of giving contractors a “blank check” to spend on bridge repairs will stop. Hard control limits will save all levels of government hundreds of millions of dollars in unplanned cost overruns and potential contractor abuse of the system.

The microwave based GPR system of the present invention also has another strength not traditionally recognized by or available to users: the ability to determine very efficiently if concrete pavements have been contaminated by environmental conditions and road salts to the point where they have become highly conductive to electrical currents and therefore highly susceptible to accelerated future reinforcing steel corrosion. This important information can be collected at the same time anomaly depth information is collected for calibrating the IR delamination data. This means that if significant percentages of the entire bridge or roadway pavement has been contaminated to the point where it is susceptible to future accelerated deterioration, the decision to “Replace” or “Repair” the bridge or roadway pavement becomes more technically and economically justifiable through uses of the new system. Less money will therefore be wasted on performing repairs destined to rapidly fail.

### BRIEF DESCRIPTION OF THE DRAWINGS AND IMAGES

FIG. 1: BLOCK DIAGRAM OF SYSTEM COMPONENTS in accordance with the invention.

FIG. 2: EXAMPLE OF VISUAL HD VIDEO DATA OR STILL IMAGE DATA AUTOMOBILE IS LEFT IN DATA FOR RAPID SIZE ESTIMATES.

FIG. 3: EXAMPLE INFRARED ENERGY PATTERN (IR) DATA.

FIG. 4: EXAMPLE 1 OF LIDAR DATA (DATA ZOOMED OUT).

FIG. 5: EXAMPLE 2 OF LIDAR DATA (DATA ZOOMED IN).

FIG. 6: EXAMPLE 3 OF LIDAR DATA: (DATA ZOOMED IN ON DOUBLE CURSER BEING USED TO TAKE ON-LINE MEASUREMENTS WITH HIGH ACCURACY).

FIG. 7: EXAMPLES OF GPR DATA FOR BOTH DELAMINATION DEPTH MEASUREMENT AND DETECTION OF HIGHLY CONDUCTIVE CONCRETE LOCATIONS:

FIG. 8: (GIS) GEOGRAPHICAL INFORMATION SYSTEM SETUP.

FIG. 9: EXAMPLE OF ANALYZED VISUAL HD VIDEO DATA OR STILL IMAGE DATA SHOWING PAVEMENT PATCHES & EXISTING DAMAGED AREAS.

FIG. 10: EXAMPLE OF ANALYZED IR HD VIDEO DATA OR STILL DATA IMAGE SHOWING AREAS OF PAVEMENT PATCHES, AREAS DETECTED AND IDENTIFIED AS HAVING HALF-DEPTH DELAMINATIONS AND AREAS DETECTED AND IDENTIFIED AS HAVING FULL-DEPTH DELAMINATIONS.

FIG. 11: EXAMPLE REPORT INDIVIDUAL BRIDGE SPAN SUMMARY PAGE ILLUSTRATING PATCH AREAS, HALF-DEPTH DEFECTS & FULL-DEPTH DELAMINATION AREAS

FIG. 12: EXAMPLE OF MILE LONG BRIDGE DATA OVERALL MASTER EXECUTIVE SUMMARY PAGE

FIG. 13: EXAMPLE OF REPORT INFORMATION PAGES AVAILABLE FOR COMPUTERIZED LAYERING WITH HIGH ACCURACY

FIG. 14: EXAMPLE OF CALIBRATION CHART

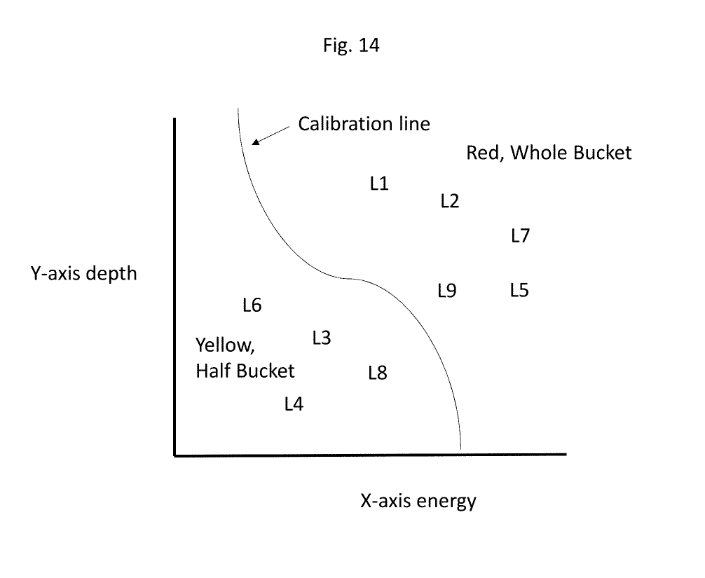

### DESCRIPTION OF PRACTICAL EMBODIMENT(S) AND MODES FOR CARRYING OUT THE INVENTION

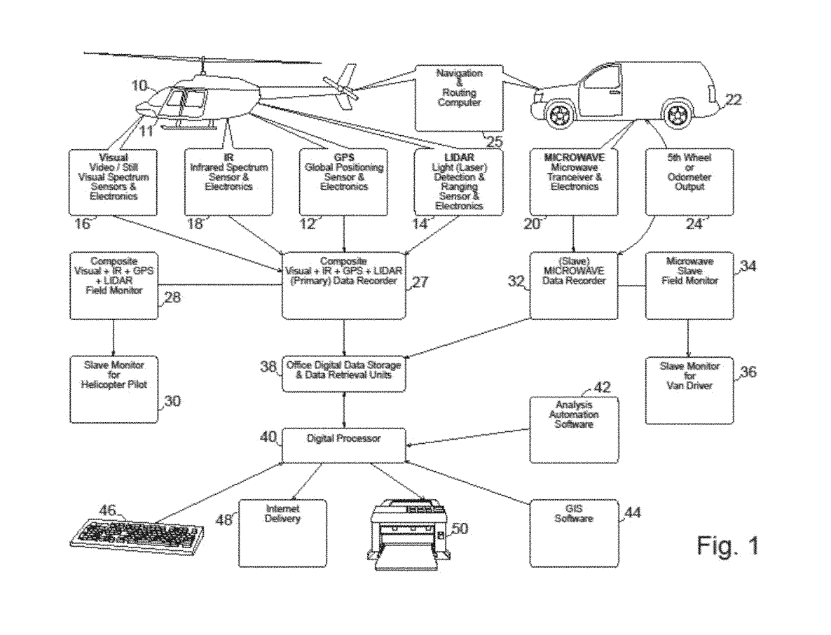

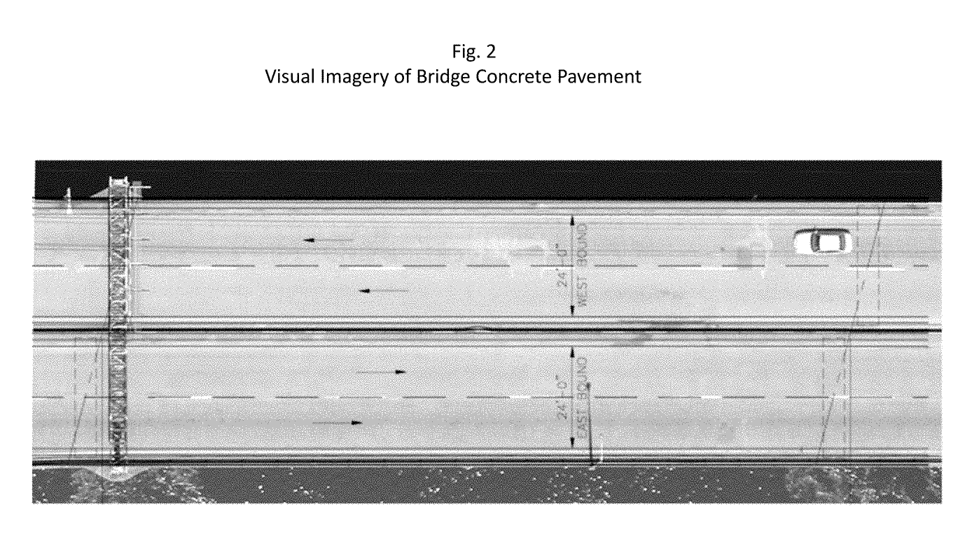

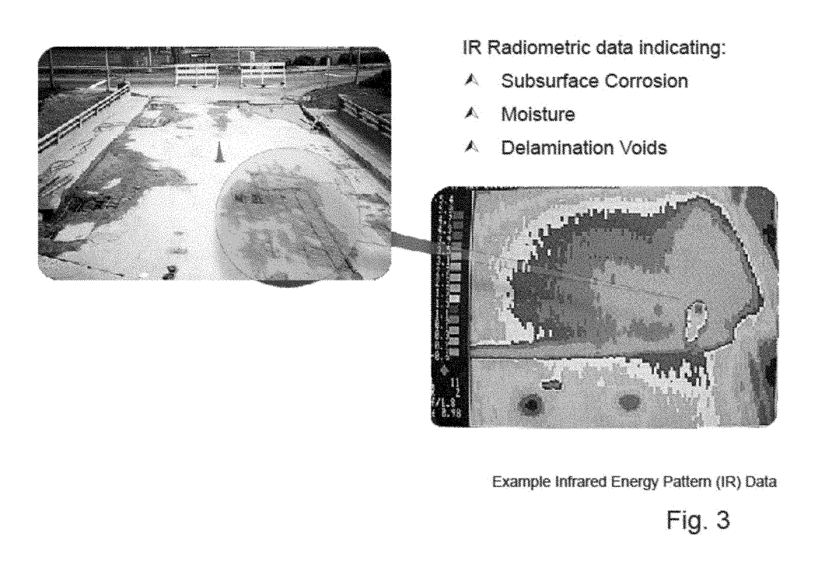

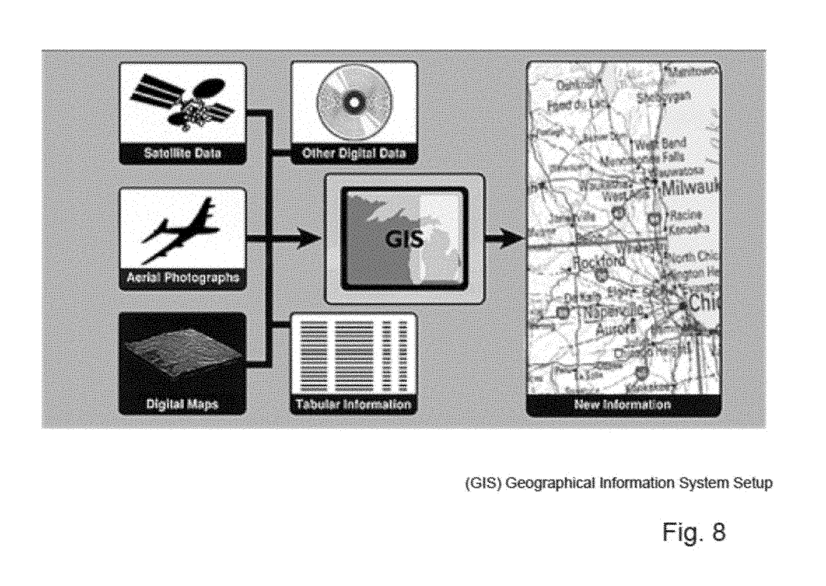

The new system is illustrated in block diagram (FIG. 1) and photographs FIG. 2 through FIG. 13 and is generally referred to as system for structural bridge, roadway and parking area defect detection, being useful also for investigation of other paved areas. The system includes an aerial equipment mounting platform 10, either rotary or fixed wing aircraft, with the following mounted systems: Global Positioning System (GPS) 12; and further comprising a Light Detection and Ranging System (LIDAR) 14; and further comprising a Visual Imaging (VI) system 16 using visual regular or high definition (HD) video/still camera systems; and further comprising an infrared (IR) thermographic system 18; all carried by aircraft 10 in an equipment pod 11, and further comprising a synched microwave Ground Penetrating Microwave Radar (GPR) system 20 in a ground (land) vehicle 22 (here, an auto motive van) and distance measuring device such as a fifth wheel 24 or transmission sensor. The fifth wheel (as attached by braces to the vehicle) provides pulse units per distance units travelled by the mobile system. In lieu of the fifth wheel a known pulse-type odometer unit may be employed, so as to provide to a converter a predetermined number of pulses per increment of system travel. A navigation and routing computer (microprocessor) 25 converts the above ratio into distance units that are transmitted to the GPR system mounted on the separate, but synchronized, van designed to drive over specific areas of the structure being investigated.

Prior to performing any field data collection office based personnel selects the most efficient route over the surface of the bridge or road for collecting field data by both the aircraft 10 and the synched ground vehicle 22. This plan will include use GPS coordinates for all target infrastructure to be investigated each day or night. Routing software determines the most efficient data collection route and deliver this information to both field data collection vehicles.

The aircraft 10 is equipped and configured to fly and collect (by its equipment pod 11) remote sensing data from all synchronized sensor systems between altitudes of generally from 500 ft. AGL (above ground surface level) to 10,000 ft. AGL or greater depending upon the target infrastructure being investigated. Both sensor platforms 10 and 22 will be capable of collecting data at normal safe airspeed and/or driving speeds so that no areas need be shut down or restricted to the public.

The use of aerial mounted remote sensing sensor systems (by aircraft 10 and its pod 11) is designed to accomplish specific objectives: Allow extremely rapid, real-time, data collection so that ambient conditions such as temperature, relative humidity, solar loading/cooling, shadow areas, surface debris and traffic conditions do not change during the data collection process on each structure. This significantly contributes to accurate, repeatable and structure-to-structure comparison capabilities.

Each sensor system has a specific contribution to the whole system's objectives. 1) The GPS system 12 is designed to locate the helicopter location in 3-dimensional space to accuracy between 1.0 in. and 1.0 ft. The output of the GPS system 12 is synchronized to the LIDAR system 14. 2) The LIDAR system 14 sends laser light pulses to the various target surfaces and measure the angles of each pulse relative to the aircraft and the time for the light pulse to be sent and returned to the LIDAR system. Post processing is then used to establish the location of every target surface in 3D space accuracy between 1.0 in. and 1.0 ft. depending upon client requirements. The LIDAR location information is then synched to the Visual Imaging System (VIS) 16 of regular or high definition (HD) video or still imagery cameras in order to synch the visual imagery data to accurate location information for the target location represented by every pixel in the visual imagery data. The visual imagery data is designed to allow the location of past repair patch locations as well as presently existing spalled or deteriorated structure surfaces. The LIDAR system 14 is also synchronized with the IR camera system 18. The IR camera system is used to locate subsurface moisture trails, debonding of asphalt overlays, as well as half-depth and full-depth delaminations or voids caused by the corrosion and rusting of concrete embedded reinforcing steel. The infrared camera (system 18) measures only surface energy levels, which necessarily are affected by ambient conditions such as temperature, relative humidity, wind speeds and surface emissivity. Additionally, surface energy levels are affected by the presence of voids or other geological anomalies which act as insulators, retarding the flow of energy into or out of the surrounding materials. To illustrate, during daylight hours, the pavement surface absorbs heat from the sun and transfers it to the earth's mass beneath the pavement. The presence of an anomaly slows heat transfer so that the surface above the anomaly becomes warmer as the heat pools there. At night, the process reverses. The pavement yields radiant energy to the relatively cooler night sky; however, a void below the surface slows transfer of heat from the earth to the surface. Thus at night, the surface temperature above an anomaly is lower than the surrounding material surfaces. Appropriate IR camera lenses and video/still camera lenses are employed to enable the system data frames to incorporate the entire width of the target area in one “pass”, or drive-over or fly-over. The infrared data shows the size and shape and by synching with the other sensors, the exact location of each target beneath the surface.

The composite data (Visual+IR+GPS+LIDAR data) is collected at a primary data recorder 27. A data collection specialist in the aerial platform will be using a real-time monitor 28 showing of all of the above data. A slave monitor 30 for the pilot will be used by the pilot to assist him in tracking each structures location for data collection as assisting the pilot in accurately framing each structure's data collection; and as illustrated, a (slave) microwave data recorder 32 receives GPR output and provides data to a microwave slave field monitor 34 and to a slave monitor 36 for the van driver.

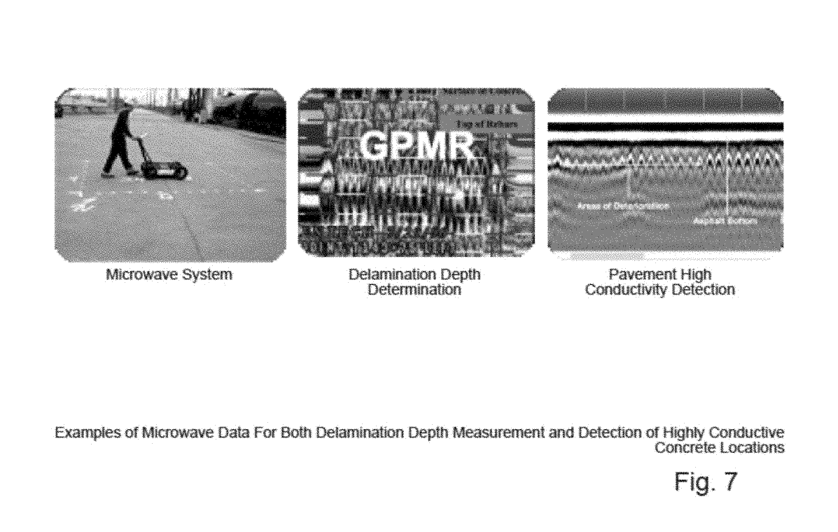

Data is synchronized with the ground vehicle that drives over the selected bridge or road surface area shown by the IR camera system 18 to contain multiple locations having a delamination at each location, each delamination having a specific energy level. The GPR 20 system will supply data as illustrated in FIG. 7: Examples of microwave data for both delamination depth measurement and detection of highly conductive concrete locations, and synchronized with all the other sensor systems and in post processing, develop a calibration chart that will include the energy level on the X-axis and the concrete thickness on the Y-axis for each location Lx as determined by GPS. The resultant calibration curve is used to determine the general depth of each delamination and classified as either a Half-Depth Delamination or a Full-Depth Delamination (that is, within the top half of the concrete or the top and bottom halves both of the concrete, respectively).

The composite data (Visual+IR+GPS+LIDAR data) is collected at a primary data recorder 27. Each day's or night's data collection, from both the aircraft 10 and ground based vehicle 22, has their data downloaded by use of the Internet, or portable hard drives, or other digital data storage and transmittal methodologies to a central data storage and processing center, in FIG. 1 being identified as Office Digital Data Storage & Data Retrieval Units, being designated 38.

At the processing center the synched raw data (from units 27 and 32) is processed using a digital processor 40 providing automatic and manual software, as by Analysis Automation Software 42 and GIS Software 44 and with use of a keyboard 46 so as to construct layers of synched data. The processed data can be delivered by Internet, as designated 48, or by printer shown at 50.

The foregoing procedures, system features and methods are used to obtain data depicted as follows:

Refer to FIG. 2 which is an example of Visual Plan view HD Video Data or Still Image Data obtained from the foregoing procedures and methods. In that figure, an aerial visual plan view of a section of four-lane interstate highway at a bridge deck of a bridge crossing a major river is shown, there being visible the data remaining of a vehicle in one lane for size reference.

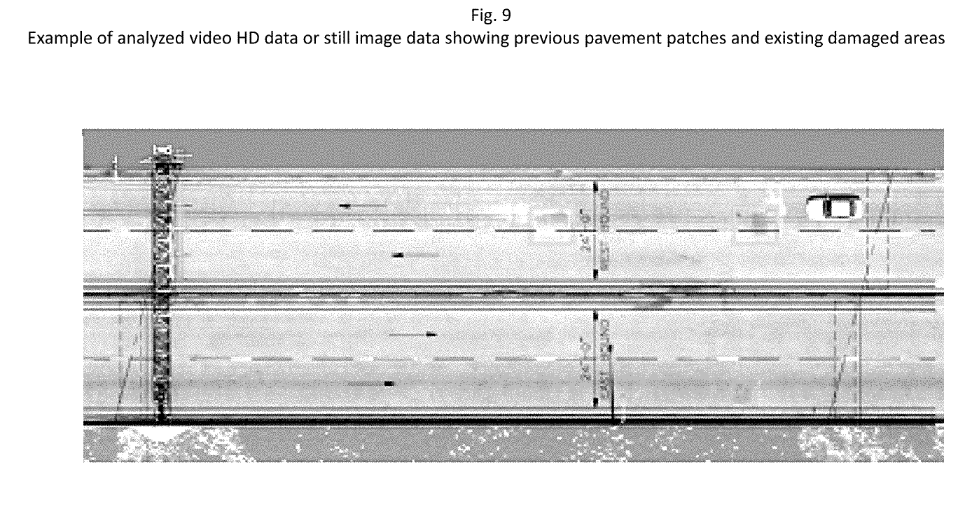

Refer then to FIG. 9, which is an example of Analyzed Visual HD Video Data or Still Image Data, using techniques herein described, showing pavement patches and existing damaged Areas which by analyzed data have been determined to exist.

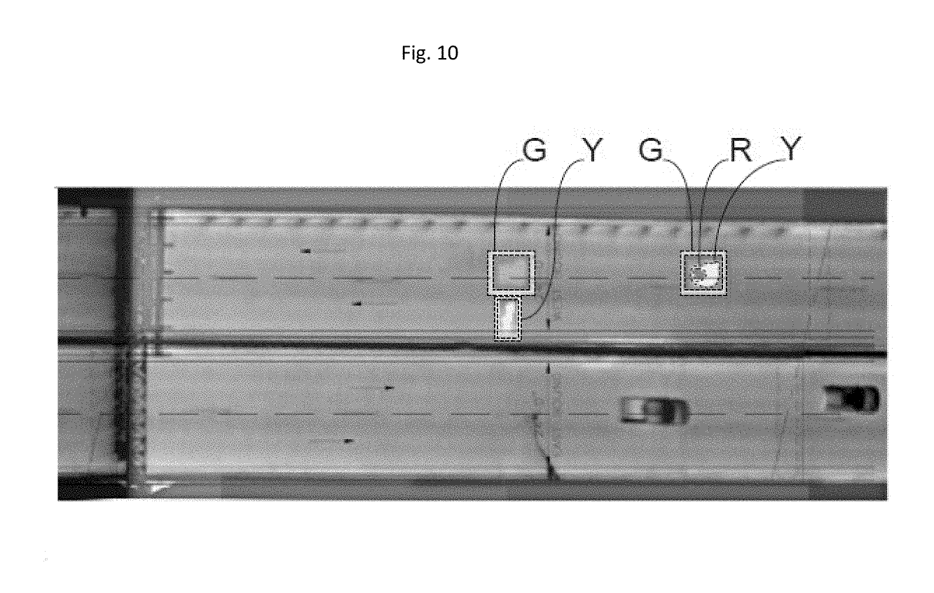

Refer then also to FIG. 10, an example of Analyzed IR HD Video Data or Still Data Image showing the detected pavement patches (preferably identified by color display in green), half-depth delaminations (preferably identified by color display in yellow) and full-depth delaminations (preferably identified by color display in red). The areas of colors green, yellow and red are symbolized in the Figures by the letters G, Y and R.

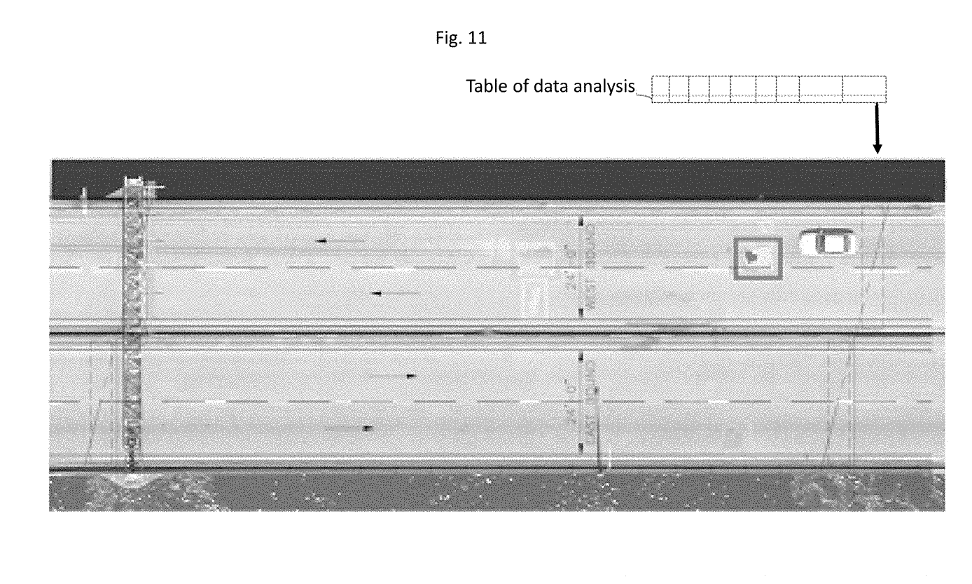

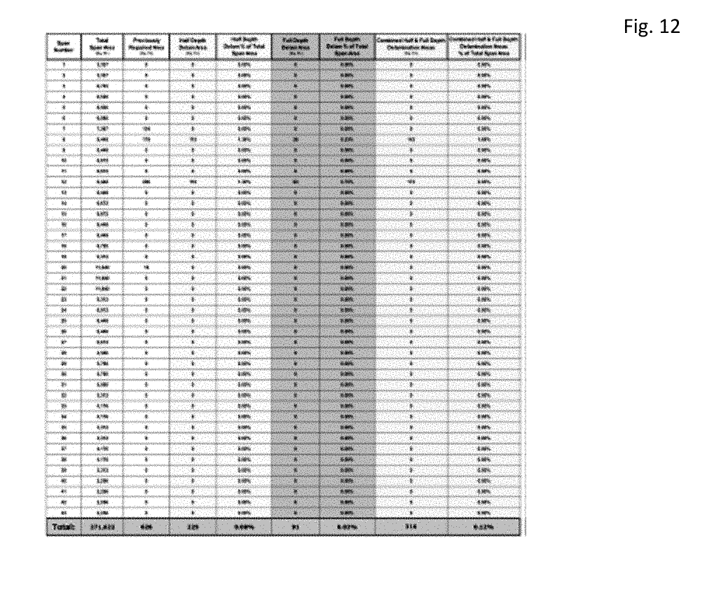

FIG. 11 is an example report individual bridge span summary page illustrating patch areas. An automobile image remains in the view for illustration of relative size of repair and delamination areas. FIG. 12 is a bridge data overall master executive summary page in tabular form summarizing the system data obtained by experimental use of the system to evaluate a specific major river bridge deck pavement for corrosion- and stress-caused delaminations of the deck pavement.

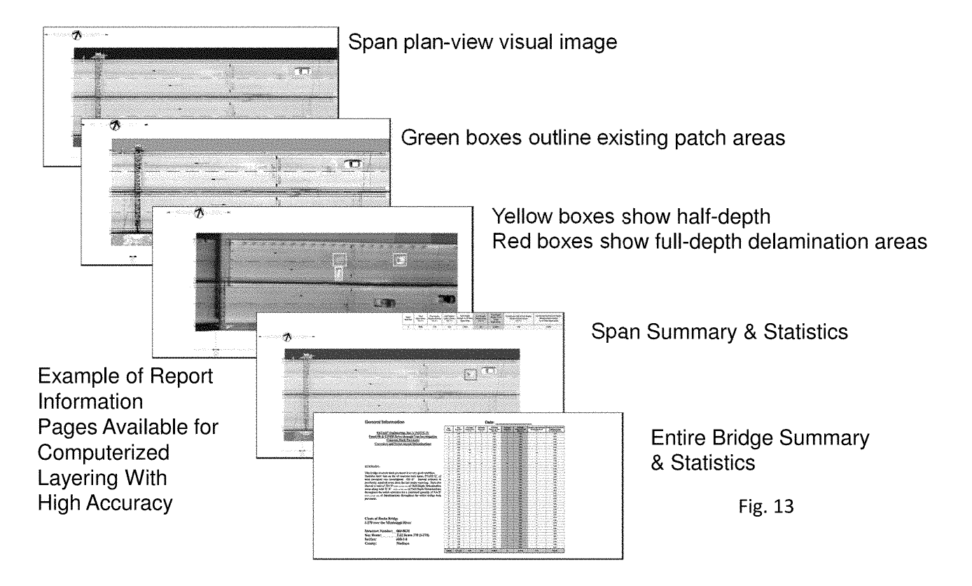

FIG. 13 is an overlay example illustrating the types information displays provided by the inventive system, including a bridge span plan-view visual image, an overhead view showing existing patch areas, an overhead view showing both half-depth and full-depth delineation (damage or fault) areas, a span summary overhead view, and a tabular entire bridge summary with statistics of the type shown in FIG. 12, namely a bridge data overall master executive summary page. These computer layers of information are constructed and stored by system computer media as illustrated in FIG. 13 showing the overlay example of report information pages available for computerized layering with high accuracy.

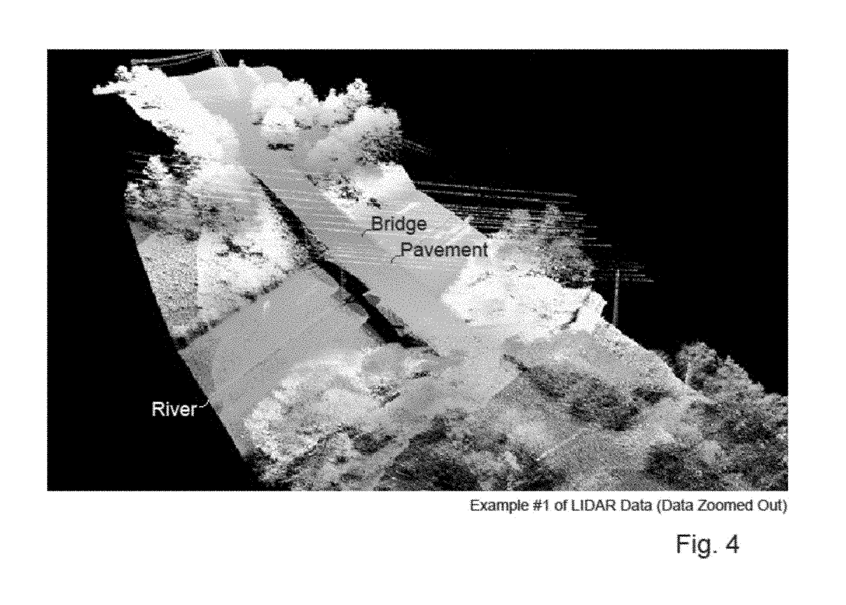

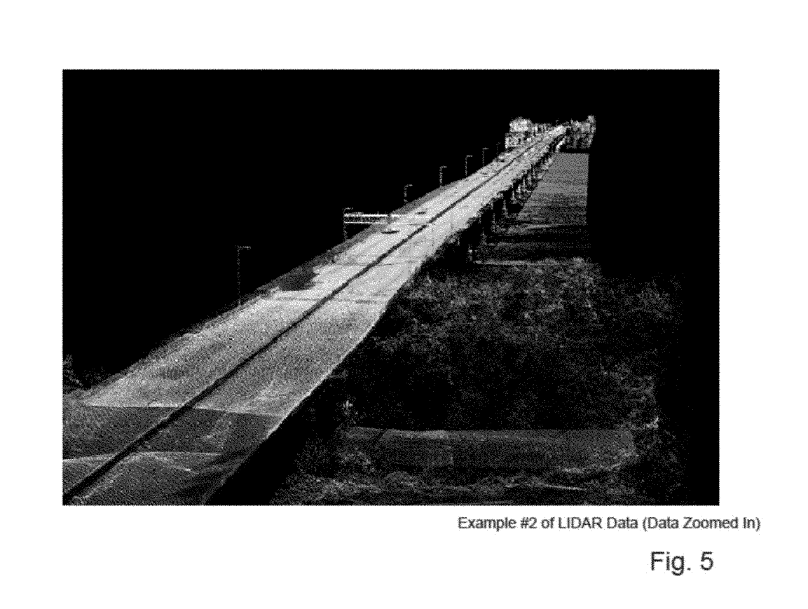

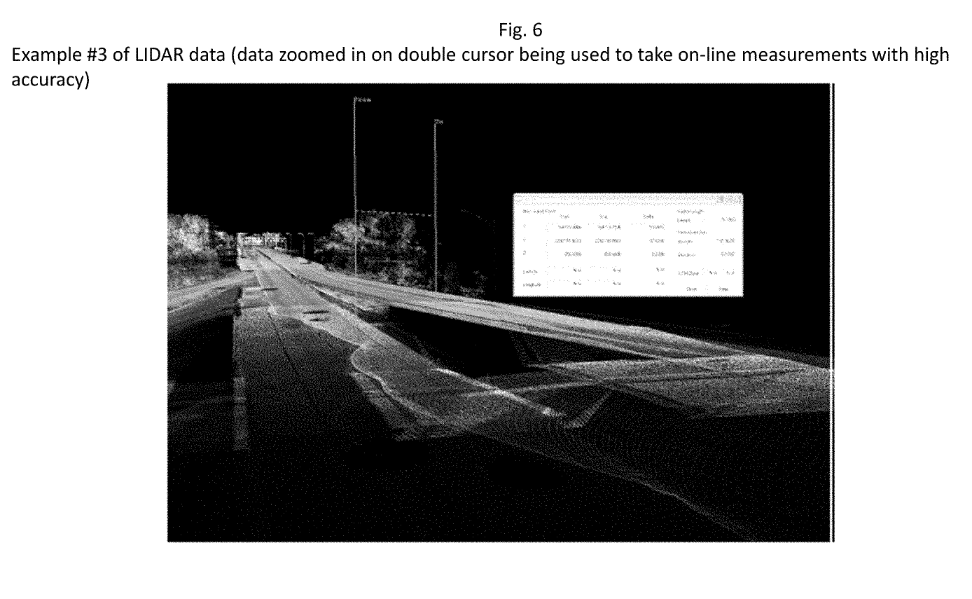

In addition to the layered data analysis results, processed LIDAR data will be stored along with GIS software to allow various types of free-flow data analysis through virtual measurements as illustrated in FIGS. 4, 5 and 6. Thus, FIG. 4 is Example #1 of LIDAR Data: (data zoomed out); FIG. 5 is Example #2 of LIDAR Data: (data zoomed in); FIG. 6 is example #3 of LIDAR Data: (data zoomed in on double curser being used to take on-line measurements with high accuracy).

After all data is processed it is backed up and transferred to a client or to clients using the Internet (as at 48) and/or hardcopy data (as by printer 50) or by DVD, hard drives, or other digital electronic data transfer protocols.

### EXAMPLE OF SYSTEM OPERATION

### Objective: Detection of Bridge Damage Due to Deck Pavement Corrosion, Support Column Scour and Deck Support Bearing Failure

The following serves to illustrate typical operation of the invention. A bridge that the inventor herein uses to illustrate this invention is the Interstate-270 (I-270) Mississippi River Bridge located between St. Louis, Mo. and Granite City, Ill. This bridge is approximately 5,280 feet long and is four (4) lanes (50 ft.) wide. To illustrate the value in savings of cost and time made possible by the inventive system, the inventor points out having his has been employed by a number of different engineering firms since approximately 1983 to investigate the condition of the bridge concrete deck for the a state Department of Transportation (IDOT), in a period of over 25 years. A common thread through all of these condition investigations was that no standard was given to the inventor to which to adhere. How the structure was to be heretofore investigated was totally up to the inspector, and no continuity or repeatability or comparability was expected. The first investigation technique used in approximately 1983 used an early form of Infrared thermography and chain dragging and required three (3) nights of bridge closures. The second condition investigation was performed in approximately 1992 and employed only ground penetrating microwave radar. It required 10 days of lane closures. The third condition investigation was performed in approximately 1999 and was based on a combination of infrared thermography and ground penetrating microwave radar. This investigation required only a single night of rolling lane closure. A fourth bridge condition investigation was performed on Aug. 14, 2007 and performed during daylight hours but again with a combination of infrared thermography and ground penetrating microwave radar. This time the ground microwave system was used only to calibrate the Infrared data as to the depth of the subsurface delaminations that were detected. The field data collection was performed with the data collection vehicle continuously moving at normal traffic speeds. Data collection for the entire approximately 320,000 sq. ft. of concrete bridge deck was performed in less than 4 hours with no traffic lane closures.

Several days later, a repeat deck condition investigation on the same approximately 320,000 sq, ft. of concrete deck pavement with a new experimental development configuration. These two investigations were performed to take advantage of the opportunity to have comparison data on which to perform accuracy comparison evaluations.

This fifth experimental development condition investigation took approximately 15 minutes of helicopter flight time and 10 minutes of on-deck driving time for data collection. The drive-on data collection vehicle was also used to setup a portable standard LIDAR-GPS reference station for use during the flyover to achieve post processing location accuracy of greater than +/−2 inches for the LIDAR data.

The overall bridge and associated ramps and roadways investigation data collection process began by using a nearby helicopter service area to install the invention's sensor systems including: GPS, LIDAR, visual spectrum regular & HD video and digital still cameras and an IR HD thermographic camera. All of the sensor systems were electronically synched together to insure all data applied to the same corresponding locations and were traceable using a standard State approved GPS coordinate system. A separate GPS navigation system was installed in the helicopter to use in locating target bridge or roadway targets using the most efficient routing during flight missions. This added piece of equipment would be of great value when large numbers of bridges or roadways needed to be investigated. Lenses for all optical systems were installed to allow data collection at approximately 700 ft. above the target elevation. This elevation would allow the entire deck width to be in all frames and the ability to adjust the frame data collection rate on all systems would allow each frame to have approximately 40% overlap. This approximate overlay would allow subsequent data processing to construct accurate panoramic views of all bridge deck areas with minimal manual processing for each deck.

Prior to the helicopter taking flight, the ground vehicle is set up as a ground GPS reference station to establish ground reference points for the helicopter GPS and LIDAR systems. The helicopter then takes flight and proceeds at 700 ft. of altitude to the bridge by following the navigation computer to the bridge. At the target bridge both pilot and the data collection engineer/technician view their individual computer monitors. The pilot lines up the target areas to collect GPS, LIDAR, data on and the data collection engineer/technician makes all sensor system adjustments to allow automatic system and manual systems to allow proper data collection and data storage. Simultaneously both aerial systems and ground reference and GPR systems have their synchronization systems synced and operations are confirmed. The helicopter pilot then flies over the bridge and/or roadway targets. During this bridge investigation the data collection took a total of 15 minutes. Since only a single bridge was targeted for data collection, the helicopter then returned to base for downloading of all aerial data over the Internet to the central office data storage system. Following the aerial data collection flight the ground vehicle crew used the ground vehicle with the GPR antenna transceiver system mounted on the vehicle front bumper system over the bridge location with the most pavement delaminations as determined by the aerial system and synced to the ground vehicle. As a redundant ground data collection protocol, if sync is lost between the aircraft and ground systems, the ground vehicle crew will drive over the bridge or roadways with the GPR antenna positioned over the right lanes right tire wear location as observed by the vehicle driver. Experience on collecting deterioration data on over 600 bridges has shown that bridge and/or roadway deterioration occurs most often in this location due to heavy traffic usage. Following completion of the ground vehicle data collection, the vehicle returns to a predetermined location to download its stored data to the central office data storage system using the Internet.

In a preferred embodiment of the invention, the vehicle with the GPR device makes a single pass over the selected surface of the bridge or road when taking data. GPR analysis is typically gathered by moving the device over the surface in a tight grid pattern, particularly when the GPR data is used to determine the volume of the void or defect. It has been found, surprisingly, that the combination of infrared energy data with the single-pass GPR data to determine depth in a calibration chart provides accurate data for determining the size of the delamination. The size is labeled “full bucket” or “half bucket” which refers to the amount of new concrete needed to fill the hole made after the delaminated concrete is broken up and removed for repair. Providing this data to the repair crew improves efficiency and reduces repair costs. In another preferred embodiment, both the infrared data taken with the aircraft and the GPR data taken with the vehicle are taken with a single pass over the selected surface, allowing for the rapid collection of subsurface data.

When all bridge GPS+LIDAR+Visual Imagery+IR Thermographic+GPR digital aerial and ground vehicle sensor systems data have been received and stored at the central business location processing is initiated.

The first step in the processing is to develop a calibration chart from a combination of the IR information and further comprising the GPR depth information at specific locations from the shallowest to the deepest delamination depths. This produces a calibration chart for each delamination location Lx with the surface pavement energy level of the delamination on the Y-axis and the depth as determined by the GPR system on the X-axis. The number of data points is dependent upon how many delamination locations Lx have been detected. Subsequent processing develops a list of all delaminations, their locations, and their depth as determined from the calibration chart. For simplification, these depth determinations are sorted into half-depth & full-depth “buckets” for color coding such as RED for full-depth delaminations and YELLOW for half-depth delaminations. The data for this bridge is then processed as illustrated in the Figures.

The LIDAR data is further processed and loaded into an industry standard GIS system so that a client can perform additional virtual queries and measurements according to the client's own requirements and without leaving the client's office computer facility.

Following this initial development test, the inventor estimates that an average 20 bridge or roadway structures can be investigated per 8-hour day.

In view of the foregoing, it will be seen that the objectives of the invention are achieved and other advantages will be obtained such as lower cost per sq. ft. unit costs will be achieved. A simple empirical comparison of testing results performed by one department of transportation (DOT) of a USA midwestern state in which the DOT used 30 inspectors to evaluate 76 bridges in a given year. By comparison, the new invention's requirements of an aircraft pilot+data collection engineer/technician+target scheduling navigator+analysis supervising engineer +4 analysis technicians totals 8 persons to collect data and perform analysis services for approximately 2,400 bridges of all sizes during a typical 6 month summer season. A simple analytical comparison shows the state DOT uses resources of: (76 bridges×5,000 sq. ft./average bridge/season)/30 persons vs. the new invention's requirements of (2,400 bridges×5,000 sq. ft./average bridge/season/8 persons) shows a simple ratio of costs comparing the government's cost present system costs verses the new inventions estimated costs is: 118 to 1. In simple terms savings will be 99% of what existing costs are for services and information that will be dramatically more comprehensive and more accurate.

Some Aspects and Variations of the System:

As described above, a selectively mobile system of the invention utilizes multiple sensor systems and provides fusing of their data for evaluating surface and subsurface aspects of typical bridge and roadway infrastructure. These sensor systems include: 1) GPS (Global Positioning System); 2) LIDAR (Light Detection and Ranging system; 3) Visual Video/Still camera(s); 4) Infrared Thermographic (IR) camera(s) and 5) GPR (Ground Penetrating Microwave Radar). The GPS & LIDAR systems establish common and repeatable location information for all results of the bridge and roadway condition investigations. The visual video/still camera data is designed to assist in locating and illustrating past patch areas as well as existing concrete deterioration such as spalling. The IR thermographic sensor systems are designed to detect and assist in determining the depth of internal concrete corrosion caused delaminations. The GPR system is designed to assist in calibrating the depth of the previously detected delaminations. The new system may include other sensors which may also be used for additional information such as profilometers for measuring surface irregularities which can benefit from the fusion of accurate location information from the GPS & LIDAR sensors systems. Sensing elements of the system are carried by a mobile carrier, namely a mobile vehicle, such as most preferably a helicopter, or by specialized vehicle, such as van outfitted specifically with the sensing elements.

A video monitor may be employed for viewing composite data frames provided by the video/Still camera. The video processing provides successive video frames for storage by a video recorder and a video monitor for independent viewing of video/still images provided by the video/still camera. So also, a separate monitor preferably can be used for independently viewing the infrared images provided by the infrared thermographic system.

It is preferred to use a keyboard, as at 46, coupled to the processor, designated at 40 in FIG. 1, for selective operator provision of information relevant to said scanning for superposition by the data processing and preservation capability on the video frame segments.

A color video/still copy processor can be added for provision of hard copy of such video/still data frame segments, as shown in the nature of a printer 50 in FIG. 1, coupled to the processor.

As a location indication the system can have distance input provision for inputting distance signals for further data processing of the geographical information system (GIS). The distance input may take the form of odometer device(s) responsive to movement of a mobile carrier, such as the helicopter herein described, for providing pulses from distance signals and distance processor means for converting such distance signals to digital form.

Regardless of its type, the mobile vehicle has mounting facility upon which said sensors system components are adjustably affixed for precise aiming and alignment and such components are, as hereinabove described, said infrared camera and said video/still camera.

The system further comprises features for data processing and preservation comprising at least one video recorder; and video processing for processing the infrared and video images and location data to provide a composite video output of the superposed infrared image, video image and location data to the video recorder for recording.

With regard to the features for data processing and preservation, the system uses location data uniquely representative of locations of such geological area within for causing the captured infrared images to have color spectrum indicative of preselected temperature for video recorder capture of such colors.

The features for data processing and preservation most preferably are configured to provide a composite video output of the superposed infrared image, video image and location data to the video recorder for recording, so that all such data are preserved for analysis.

For capture of such data, the system further comprises a computer recorder of the multi-channel type for simultaneous recording on separate channels of information relevant to such geological scanning.

So also, the system is configured to further comprise a video editor by which such video recorded infrared and visual data may be edited; and an edit-output recorder for storage of such edited video recordings.

A system further comprises videotape recording provision for audio recording of information simultaneously with the videotape recording. In addition, the system comprises automated marking facility; whereby to impose indicia upon selected geological sites during the course of the data collection of such sites.

As to the manner of recordation, the system video processing facility provides successive video frames for storage by a computer video recorder. In this regard, video frame includes a plurality of discrete segments; one of such segments carrying a captured infrared image of such scanned geological area and another of the segments carrying a captured video image of such scanned geological area. The video processing is such that each video frame includes a further segment carrying the location synced data referencing information and at least one further segment for carrying additional information relative to said data collection.

Regarding video capture, it is preferred that the system comprise at least one further video camera for visual scanning while evaluating such geographical area, one of the video frame segments carrying a video image captured by said further video camera.

Although the foregoing includes a description of a best mode contemplated for carrying out the invention, various modifications are contemplated. As various modifications could be made in the constructions, methods and uses herein described and illustrated without departing from the scope of the invention, it is intended that all matter contained in the foregoing description or shown in the accompanying drawings and photographs shall be interpreted as illustrative rather than limiting.

1. A method of detecting, locating and evaluating bridge and roadway subsurface defects comprising:
a. flying an aircraft having an infrared camera and GPS device mounted on it over a selected surface of the bridge and roadway;
b. operating the infrared camera and GPS device to scan the selected surface of the bridge and roadway and creating infrared data and GPS data;
c. driving a vehicle having an odometer and a Ground Penetrating Radar (GPR) device mounted on or under it over the selected surface of the bridge and roadway;
d. operating the GPR device and scanning the selected surface of the bridge and roadway and create GPR data;
wherein the infrared data and the GPS data are digitally stored in the data storage unit;
wherein the GPR data and the odometer data are digitally stored in a data storage unit;
wherein the GPR data, the odometer data, the infrared data and the GPS data are digitally transferred to a processor;
wherein the GPS data is processed in a processor to determine each location (Lx) for the GPR data and infrared data;
wherein the GPR data is processed by a processor to generate depth data for the determined location;
wherein the infrared data is processed by the processor to generate energy level data for the determined location;
wherein a calibration chart for each location Lx is generated by plotting for each location on the Y-axis the infrared energy level and on the X-axis the GPR depth; and
wherein the calibration chart is used to establish the depth and size of the defects for each location.

2. The method of claim 1, wherein the GPS and infrared data are used to find the location of defects in the subsurface of the bridge or road, and wherein the location is used to determine where on the selected surface the vehicle taking GPR takes data.

3. The method of claim 2, wherein the vehicle takes GPR data in a single pass.

4. The method of claim 3, wherein the calibration chart is used to determine if the defect is large and is a whole bucket repair or is small and is a half bucket repair.

5. The method of claim 1, wherein the vehicle is driven with the right tire in the right lane and the GPR device located next to the vehicle's right tire to locate defects.

6. A method of locating bridge and roadway subsurface defects and more accurately determine the cost of repair of the defects comprising:
a. flying an aircraft having an infrared camera and GPS device mounted on it over a selected surface of the bridge and roadway;
b. operating the infrared camera and GPS device to scan the selected surface of the bridge and roadway and creating infrared data and GPS data;
c. driving a vehicle having an odometer and a Ground Penetrating Radar (GPR) device mounted on or under it over the selected surface of the bridge and roadway;
d. operating the GPR device and scanning the selected surface of the bridge and roadway and create GPR data;
wherein the infrared data and the GPS data are digitally stored in the data storage unit;
wherein the GPR data and the odometer data are digitally stored in a data storage unit;
wherein the GPR data, the odometer data, the infrared data and the GPS data are digitally transferred to a processor;
wherein the GPS data is processed in a processor to determine each location (Lx) for the GPR data and infrared data;
wherein the GPR data is processed by a processor to generate depth data for the determined location;
wherein the infrared data is processed by the processor to generate energy level data for the determined location;
wherein a calibration chart for each location Lx is generated by plotting for each location on the Y-axis the infrared energy level and on the X-axis the GPR depth;
wherein the calibration chart is used to determine if the defect is large and is a whole bucket repair or is small and is a half bucket repair; and
wherein a cost of repair is estimated using the number of whole bucket repairs and the number of half bucket repairs are needed.

7. The method of claim 6, wherein the GPS and infrared data are used to find the location of defects in the subsurface of the bridge or road, and wherein the location is used to determine where on the selected surface the vehicle taking GPR takes data.

8. The method of claim 7, wherein the vehicle takes GPR data in a single pass. wherein the infrared data and the GPS data are digitally stored in the data storage unit;

9. The method of claim 8, wherein the calibration chart is used to determine if the defect is large and is a whole bucket repair or is small and is a half bucket repair.

10. The method of claim 6, wherein the vehicle is driven with the right tire in the right lane and the GPR device located next to the vehicle's right tire to locate defects.

11. A method of detecting, locating and evaluating bridge and roadway subsurface defects comprising:
a. flying an aircraft having an infrared camera and GPS device mounted on it over a selected surface of the bridge and roadway;
b. operating the infrared camera and GPS device to scan the selected surface of the bridge and roadway and creating infrared data and GPS data;
c. driving a vehicle having an odometer and a Ground Penetrating Radar (GPR) device mounted on or under it over the selected surface of the bridge and roadway;
wherein the vehicle is driven with the right tire in the right lane and the GPR device located next to the vehicle's right tire to locate defects
d. operating the GPR device and scanning the selected surface of the bridge and roadway and create GPR data;
wherein the infrared data and the GPS data are digitally stored in the data storage unit;
wherein the GPR data and the odometer data are digitally stored in a data storage unit;
wherein the GPR data, the odometer data, the infrared data and the GPS data are digitally transferred to a processor;
wherein the GPS data is processed in a processor to determine each location (Lx) for the GPR data and infrared data;
wherein the GPR data is processed by a processor to generate depth data for the determined location;
wherein the infrared data is processed by the processor to generate energy level data for the determined location;
wherein a calibration chart for each location Lx is generated by plotting for each location on the Y-axis the infrared energy level and on the X-axis the GPR depth; and
wherein the calibration chart is used to establish the depth and size of the defects for each location.

12. The method of claim 11, wherein the vehicle takes GPR data in a single pass.

13. The method of claim 12, wherein the calibration chart is used to determine if the defect is large and is a whole bucket repair or is small and is a half bucket repair.

14. The method of claim 13, wherein a cost of repair is estimated using the number of whole bucket repairs and the number of half bucket repairs are needed.

14. The method of claim 12, wherein the aircraft takes all the infrared data in a single pass.
